(19) United States
(12) Patent Application Publication
(10) Pub. No.: US 2024/0281004 A1
(43) Pub. Date: Aug. 22, 2024

(54) METHOD FOR PREVENTING A DEADLOCK SITUATION IN A SYSTEM FOR TRANSPORTING PRODUCTS

(71) Applicant: Vanderlande Industries B.V., Veghel (NL)

(72) Inventors: Karlijn Johanna Catharina Fransen, Veghel (NL); Michel Adriaan Reniers, Veghel (NL)

(21) Appl. No.: 18/570,764

(22) PCT Filed: Jun. 16, 2022
(86) PCT No.: PCT/NL2022/050338

§ 371 Date: Dec. 15, 2023

(30) Foreign Application Priority Data
Jun. 18, 2021 (NL) 2028482

(51) Int. Cl. G05D 1/644; G05D 1/667; G05D 1/698; G05D 105/20; G05D 107/70

(52) U.S. Cl. CPC G05D 1/644; G05D 1/667; G05D 1/6987; G05D 2105/20; G05D 2107/70

(57) ABSTRACT

The present invention provides a method and system for preventing a deadlock situation in a system for transporting products. The system comprises a number of vehicles, and a central control server designed to control the vehicles, wherein the central control server comprises a digital representation of the movement area, which representation comprises a plurality of contiguous tiles. The method comprises the method steps of:—receiving an order to move a vehicle, —in response to the order, associating a vehicle with a movement path, —receiving a request from an active vehicle and/or generating for the purpose of an active vehicle a request to carry out a subsequent step of reserving at least one subsequent tile on the latter's movement path; —determining that no deadlock situation in the system arises as a result of the active vehicle carrying out the subsequent step. The determining step takes place on the basis of various parameters. The method further comprises:—at least on condition that the control server has determined that there is no deadlock situation in the system, the control server reserving the at least one subsequent tile for the active vehicle, —at least on condition that the active vehicle has received confirmation of acceptance, moving the active vehicle along its movement path so that the subsequent at least one tile is occupied, —the central control server lifting the reservation once a vehicle has completely left a tile reserved for that vehicle.

The present invention relates to the transporting of products, and more specifically to preventing a deadlock situation during such transporting. It is known practice in logistics systems to make use of a number of vehicles, where each vehicle is designed to move over a floor in a movement area. The vehicles are each designed to carry a product so that the product can be moved, for example for sorting operations. Such a system comprises a central control server which is designed to associate vehicles with movement paths to be covered in the movement area and to control the vehicles accordingly. For this, the control server comprises a digital representation of the movement area. This representation comprises a plurality of tiles that are connected to one another. In particular, as the density of vehicles in a movement area increases, so too does the risk of a “deadlock situation” arising. A deadlock situation is a situation in which a number of vehicles cannot continue on their respective movement paths because they would be in each other's way if they were to continue on their respective movement paths. In a deadlock situation, there is always a circular wait state in which, in order to be able to continue on its movement path, each vehicle from a group of vehicles needs to reserve a tile which is already reserved for another vehicle from this group. A situation in which two vehicles are opposite one another and their respective movement paths are directed towards one another should also be considered as a deadlock situation. To resolve such deadlock situations, it is known from the publication “The deadlock detection and resolution method for a unified transport system”, by K. Im, K. Kim, Y. Moon, T. Park and S. Lee (2010) for the control server to modify the movement paths so as to lift the deadlock situation. One drawback of such a reactive practice is therefore that the risk of a deadlock situation occurring is not prevented, or at least limited, and that in practice a relatively large amount of valuable time is spent in resolving the deadlock situation, as a result of which the capacity of the transport system decreases. It is also known, namely from the publication “Deadlock prevention for automated guided vehicles in automated container terminals” by K. H. Kim, S. M. Jeon and K. R. Ryu (2006), for the control server to determine at which tiles respective movement paths cross one another. There is the risk of a collision between the vehicles associated with the movement paths in question. The control server then determines a sequence in which the vehicles in question are allowed to pass through the tiles in question. This can mean that one vehicle waits for another vehicle unnecessarily if that other vehicle is delayed, for example.

The invention aims to reduce the risk of deadlock situations occurring in an efficient manner. To that end, the invention provides a method according to Claim 1. In the context of Claim 1, a deadlock situation should be considered as a situation in which the active vehicle and at least one other vehicle cannot move further along their associated movement paths because the active vehicle and the at least one other vehicle block each other's movement paths. In the method according to the invention, the reservation of a tile or of a group of tiles in order to afford a vehicle the opportunity to move along its associated movement path only takes place at least on the condition that that vehicle has made or the central control server has generated a request for such a reservation and that, in response to such a request from that vehicle, referred to hereinafter as the active vehicle, the central control server has determined that there is, at least within a given scope of the analysis for this determining operation, no risk of a deadlock situation occurring. In the analysis in question, use is made of information regarding
a the one or more tiles which would be occupied by the active vehicle in carrying out the subsequent step if the active vehicle had reached the frontmost tile of the at least one tile belonging to the subsequent step,
b the one or more tiles which have been reserved by the control server when determining, with a view to carrying out, the movement path associated with at least one other vehicle and which are occupied by the at least one other vehicle if the at least one other vehicle has reached the frontmost tile of the tiles reserved for the respective at least one other vehicle,
c at least one further tile for the active vehicle which, on the movement path associated with the active vehicle, connects to the frontmost tile to be reserved of the at least one tile belonging to the subsequent step,
d at least one further tile for at least one vehicle of the at least one other vehicle which, on the movement path associated with the at least one vehicle of the at least one other vehicle, connects to the frontmost tile reserved for the at least one vehicle.

The relative concept of “frontmost” should be interpreted above in the context of the movement of the vehicle in question in its direction of movement, thus from its starting position to its end position along its movement path. A request from an active vehicle to reserve a tile can be considered as a request for permission for that active vehicle to occupy that tile. The concept of “occupy” should in no way be interpreted as exclusively relating to a situation in which the vehicle in question is (temporary) stationary, although this is also perfectly possible. From the moment when a vehicle enters into the periphery of a tile, that vehicle occupies that tile and as soon as that vehicle leaves the tile again, i.e. has completely left the tile, that vehicle no longer occupies that tile. Such a movement of the vehicle can, for example, take place at a continuous speed or at least without the speed being zero metres per second.

The information given above under a and c relates to the active vehicle, i.e. the vehicle for which a request is made to carry out the subsequent step, i.e. to reserve the at least one tile belonging to that subsequent step, in carrying out its movement path.

Specifically for the information of a, it should be noted that depending on the size of the active vehicle and of the tiles, it may be the case that not only the at least one subsequent tile but also at least one other tile located to the rear, i.e. upstream, would be occupied if the at least one subsequent tile were occupied by the active vehicle.

The information given above under b and d relates to at least one other vehicle which together with the active vehicle could give rise to a deadlock situation. For the information under b, of relevance are only the one or more tiles which, insofar as the vehicle in question has not yet reached the frontmost tile of the tiles reserved for that vehicle, would be occupied by that vehicle if the vehicle moved as far as possible as the tiles reserved for that vehicle allowed. That therefore means that it is not necessarily the one or more tiles which is or are actually occupied by the other vehicle in question at the time of determining that there is no deadlock situation which are determinative. In particular, if the reservations make it possible for that vehicle to move further and one or more tiles are passed through completely, then the one or more reservations of that or those tiles will be lifted after having been passed through, making that or those tiles available to be reserved for the movement of another vehicle, such as the active vehicle.

The definition of the information under b additionally means that it is not necessarily the case that each tile which is reserved for a vehicle at the time of determining that there is no deadlock situation is determinative. It exclusively concerns the one or more reserved tiles which would be occupied if the vehicle in question reached the frontmost tile. Furthermore, it is not the case that any vehicle other than the active vehicle in the system constitutes a potential risk of contributing to a potential deadlock situation. Consider, for example, a vehicle at relatively far away from the active vehicle.

The information under c and d relates to tiles which should necessarily be reserved for the movement of vehicles according to their respective movement paths, but which have not yet been reserved for that purpose. By using the aforementioned information for the analysis and performing the analysis each time a vehicle makes a request to be allowed to make a subsequent step on its movement path, it is possible to respond very quickly and efficiently to the current situation at that time and waiting times for the vehicle can be reduced. Additionally, the invention very suitably lends itself for use with tiles that are smaller than the vehicles, allowing greater freedom to choose the sizes of steps for a vehicle during movement along its movement path. Such a step can therefore be smaller than the length of a vehicle, for example, if at least some of the individual tiles have smaller dimensions than those of the vehicle. Determining that no deadlock situation arises in the system as a result of the active vehicle carrying out the subsequent step occurs within the range as limited by the information of a to d. More specifically, this range is the at least one further tile according to the information of c for the active vehicle and the at least one further tile according to the information of d for the at least one vehicle of the at least one other vehicle.

That the next step being carried out by the active vehicle will not result in a deadlock situation in the system can be determined by analysing possible sequences of vehicle movements within the range mentioned above and if, for (at least) one sequence, it is determined that (with certainty) no deadlock situation will arise, or in other words that this (at least) one sequence is a (potential) free-run situation, it is determined that when the next step is carried out by the active vehicle then, within the range mentioned above, no deadlock situation will occur in the system. Determining that there is no deadlock situation could also be considered as determining that there is at least one free-run situation in said range.

It is therefore not (always) necessary for all possible sequences of vehicle movements to be analysed, namely not if, at a given time, a sequence is found that can be considered as a (potential) free-run situation and for which it is therefore determined that it will not (with certainty) lead to a deadlock situation. In general, the larger the range is chosen to be, the lower the risk of it being determined within that range that a deadlock situation will arise in the system when the active vehicle carries out the next step, and thus the lower the risk of deadlock situations actually occurring. However, a larger range may also require a more extensive analysis and therefore greater computing power.

In one embodiment of the method, the central control server determining that there is no deadlock situation in the system takes place on the basis of
at least two further tiles for the active vehicle of which the rearmost, on the movement path associated with the active vehicle, connects to the frontmost tile of the at least one tile belonging to the subsequent step, and/or
at least two further tiles for at least one vehicle of the at least one other vehicle of which the rearmost, on the movement path associated with the at least one vehicle of the at least one other vehicle, connects to the frontmost tile reserved for the at least one vehicle.

By using information relating to at least two further tiles in the determining operation, it is not necessary to perform the determining operation for each individual further tile, thereby limiting the number of determining operations that necessarily have to be performed in order for a vehicle to travel its full movement path.

A similar advantageous effect whereby efficient use can be made of available processing power may be the case if the method comprises the method step of
the central control server receiving a request and/or generating for the purpose of an active vehicle a request from an active vehicle to reserve at least two subsequent tiles on the latter's movement path;
the central control server determining that no deadlock situation in the system arises as a result of the active vehicle occupying the at least two subsequent tiles.

In such an embodiment, it may therefore be the case that the active vehicle would occupy only the frontmost tile when reaching the frontmost of the at least two subsequent tiles, but also that the active vehicle would occupy at least one of the at least one other of the at least two subsequent tiles. In the latter case, the tiles are therefore smaller than the active vehicle, at least as seen in the direction of the movement path. Depending on the size of the active vehicle and of the tiles, it may be the case that not only the at least two subsequent tiles but also at least one other tile located to the rear, i.e. upstream, would be occupied if the at least two subsequent tiles were occupied by the active vehicle.

In one embodiment of the method, the respective sizes of the steps for which an active vehicle sequentially requests a reservation from the central control server or the central control server generates such a request itself with a view to moving the active vehicle from the starting position to the end position are determined by the central control server when the vehicle is at the starting position. This in principle makes control easier to carry out than in the case where the sizes of the steps are determined during movement of the active vehicle, which in itself is also possible within the context of the present invention. Each step comprises a single tile or a group of contiguous tiles. The number of tiles that is applicable to the information of c and/or d is preferably equal to the number of tiles corresponding to the step which follows, or connects to, the frontmost reserved tile at that time for the vehicle in question. In this way, the risk of deadlock situations occurring can be reduced.

If sizes of steps which together determine a movement path differ from one another, local situations in the movement area can be anticipated. For example, the risk of a deadlock situation occurring at the edges of a movement area may be lower than in the centre of a movement area through which a relatively large number of movement paths run. This could be a reason for choosing the step sizes at the edges of the movement area to be larger than the step sizes in said centre.

One practical embodiment of the method can be obtained if the method comprises the method steps of
loading a vehicle with a product to be transported on its movement path, preferably at its starting position, and/or
unloading the vehicle on its movement path, preferably at its end position.

The invention can also very suitably lend itself to situations in which tiles differ from one another in terms of shape and/or size. Thus, for example, for parts of the movement area which are relatively busy in practice, the choice may be made to use smaller tiles than in relatively quiet parts of the movement area. Furthermore, the shape of the tiles can be adapted to the available space. In a long, narrow corridor where vehicles cannot pass each other, it may be chosen, for example, to use a tile whose shape and size corresponds to that of the corridor, although it may also be chosen to divide such a corridor into a larger number of tiles so that vehicles may follow each other relatively closely together in such a corridor.

In another embodiment, the shape and dimensions of at least one tile are such that at least one of the vehicles does not fit within the periphery of the at least one tile. The shape and dimensions of the vehicle thus no longer form a limiting factor in determining the absolute size of the steps with which a vehicle moves. A vehicle can thus, for example, move over a distance whose size is smaller than the length of the vehicle, for example only 10% or 50% thereof.

The method is also suitable for use in a system with vehicles that differ from one another in terms of shape and/or size.

The invention also relates to a system for using a method according to the invention as described above. The system is defined according to the measures of Claim 10. The advantages that can be attached to such a system will be clearly apparent to a person skilled in the art from the preceding explanation of the method according to the invention.

The invention will be explained in more detail by means of the description of possible embodiments, which are not to be interpreted as limiting the invention, of the invention with reference to the following figures:

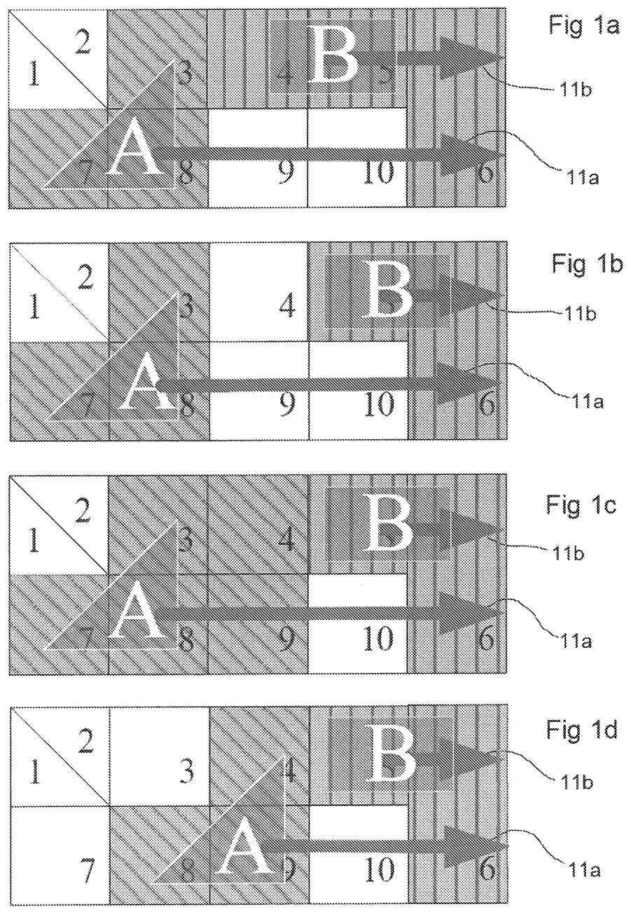

FIGS. 1a to 1d show a portion of one movement area over four successive stages in the movement of two vehicles A and B;

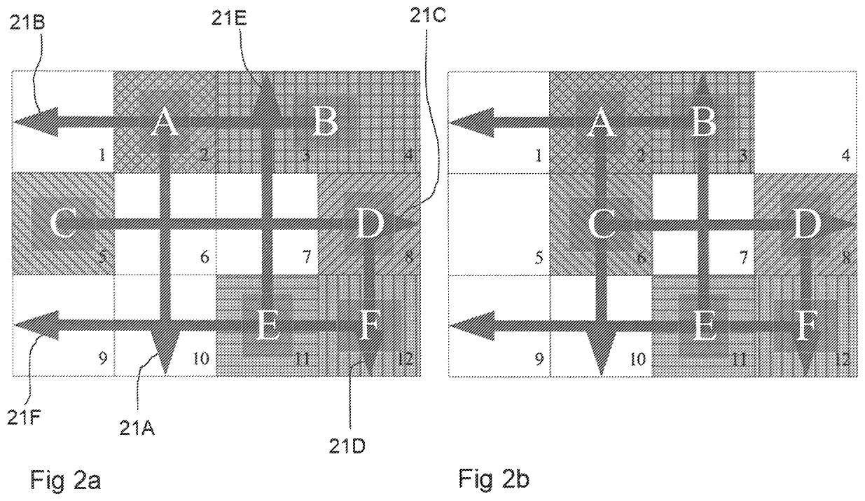

FIGS. 2a and 2b show an actual and a hypothetical stage in another movement area.

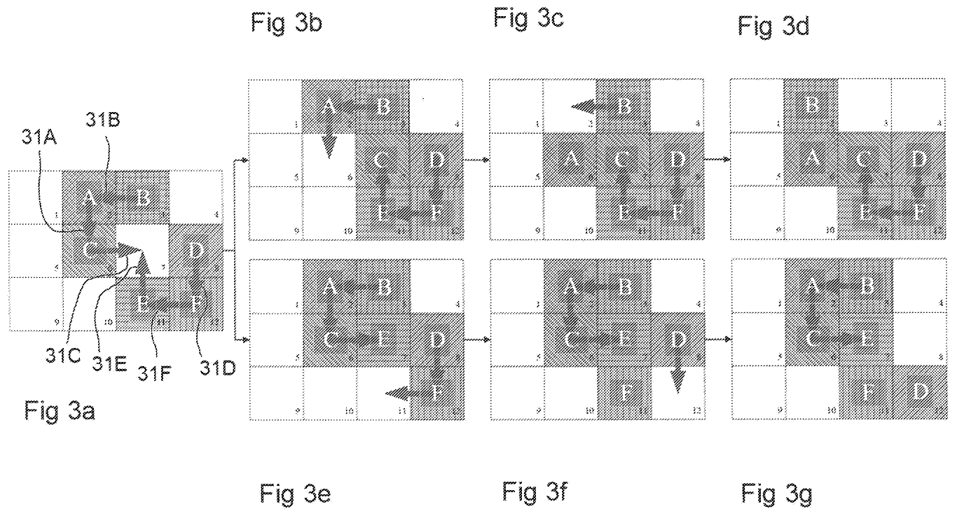

FIGS. 3a to 3g show a portion of another movement area over seven different hypothetical stages for the purpose of determining, according to a methodology, whether or not a deadlock situation will occur;

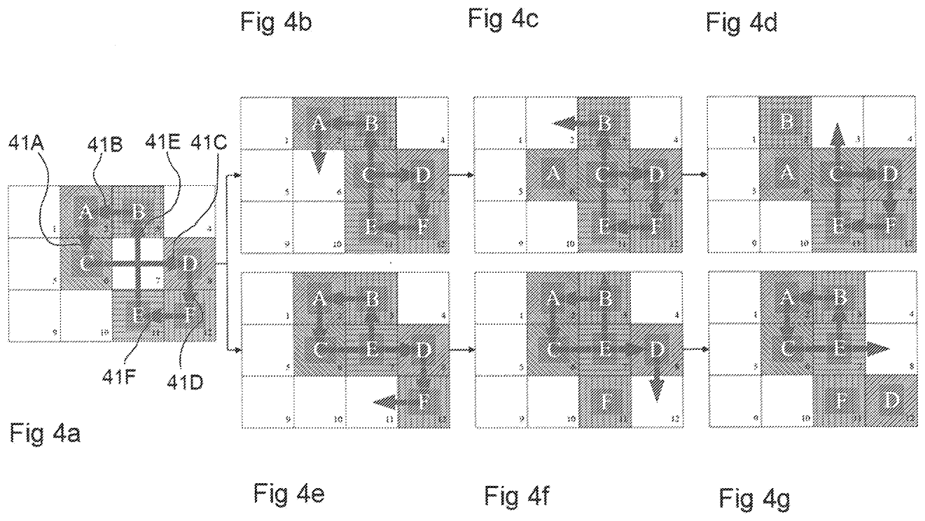

FIGS. 4a to 4g show a portion of the movement area according to FIG. 2 over seven different hypothetical stages for the purpose of determining, according to one variant of the methodology according to FIGS. 3a to 3g, whether or not a deadlock situation will occur.

By way of introduction, FIGS. 1a to 1d show a portion of a floor which is a portion of a movement area of a system for logistically transporting products. In practice, such a movement area may, for example, be a portion of the floor of a hall. Such a floor is not necessarily closed but may, for example, have openings where products may be sorted by the logistics system. The system comprises a central control server which comprises a digital representation of the movement area, in which the representation comprises a plurality of contiguous tiles. These tiles could also be represented as grid elements, mesh topologies or zones. FIG. 1 shows only a portion of the total number of tiles belonging to the movement area. The tiles shown are numbered from 1 to 10. Tiles 1 to 10 are, for example, not identical in shape: tiles 1 and 2 are in the shape of a right-angled triangle and together form a square; tiles 3, 4, 5 and 7 to 10 are each in the shape of a square whose size is the same as that of the combined shape of tiles 1 and 2; tile 6 is in the shape of a rectangle which is identical to the rectangular shape of two of said square tiles connected to one another.

The system further comprises a number of motorized vehicles which are able to move within the movement area. The vehicles each have a carrying member that is designed to carry a product to be transported. Suitable vehicles may also comprise more than one carrying member and/or more than one product to be transported may be carried per carrying member in operation. Such vehicles are known to a person skilled in art in various embodiments and are, for example, also referred to by the term of automated guided vehicle (AGV). FIGS. 1a to 1d show two vehicles A and B which, in this illustrative example, differ from one another in terms of size and shape: vehicle A is in the shape of a right-angled triangle and vehicle B is in the shape of a rectangle. Depending on the position of the respective vehicles within the movement area, each vehicle occupies at least one tile. In the stage according to FIG. 1a, vehicle A occupies tiles 3, 7 and 8 and vehicle B occupies tiles 4 and 5. What should be understood by “occupies” is the situation in which, viewed from above, a vehicle is at least partially within the periphery of the tile in question.

In operation, the central control server receives orders to move products. On the basis of an order, the central control server associates a vehicle with that order and determines a path for that vehicle to carry out the order in question. The movement path runs from a starting position, such as typically the current position of the vehicle in question, to an end position. The movement path determines which tiles will be (temporarily) occupied by the vehicle as it moves from the starting position to the end position. The central control server associates the vehicle with this movement path by sending the vehicle a (wireless) control signal in which information on the movement path is recorded. The central control server further divides the movement path into contiguous steps. Each step comprises at least one tile. If a step comprises two or more tiles, these tiles adjoin one another. Each vehicle has a local control unit which is designed to move the vehicle in question on the basis of control signals from the central control server. In this exemplary embodiment, each vehicle sends, when in operation, feedback signals to the central control server, e.g. relating to the position of the vehicle in question within the movement area. Alternatively, sensors or cameras that do not form part of the vehicles could be used to collect information on the vehicles' positions and send this information to the central control server.

In FIG. 1a, vehicles A and B have already completed a portion of their respective movement paths between a starting position and an end position. The movement paths in question are determined by the central control server while the vehicles A and B are still at their starting positions. In addition, while vehicles A and B were still at their starting positions, the central control server also divided those respective movement paths into contiguous steps, each step comprising a single tile or a group of contiguous tiles. Arrows 11A and 11B show the respective further movements of vehicles A and B along their respective movement paths. Shading is used to show which tiles are occupied by vehicles A and B. By definition, the occupied tiles are also reserved for vehicles A and B. The shading also shows other tiles that are reserved for the vehicles A and B in question. A tile reserved for a vehicle at a given time may therefore either be occupied by that vehicle at that time, or be not yet occupied by that vehicle but available for that vehicle to move to and occupy. If a tile is reserved for a vehicle, it is available only for that vehicle and is not available to be occupied by another vehicle. The control unit is designed in such a way that a vehicle can occupy a tile only if that tile has been reserved for that vehicle beforehand by the central control server at the vehicle's request. The central control server will only accept such a request by reserving the tile exclusively for that vehicle at least on condition that the central control server has determined that no deadlock situation will occur in the system as a result of this reservation. The way in which such a determining operation can be performed will be explained in more detail below by way of the description of FIGS. 2 to 3g. A reservation of a tile is lifted after the vehicle for the movement of which the tile was reserved has completely left the tile in question.

In the stage according to FIG. 1a, vehicle B occupies tiles 4 and 5 and tile 6 is reserved for vehicle B. That means that vehicle B can move further to tile 6. Such a movement took place in the stages according to FIGS. 1b, 1c and 1d.

Starting from the stage shown in FIG. 1a, a request by vehicle A to the central control server of the system to reserve tiles 4 and 9 associated with a subsequent step for vehicle A on its movement path will be rejected because tile 4 is occupied, and therefore reserved, by vehicle B. However, once vehicle B has moved on and has left tile 4, as shown in FIGS. 1b, 1c and 1d, tile 4 becomes available for reservation by vehicle A. This situation is illustrated in FIG. 1b. In FIG. 1c, vehicle A has sent to the central control server the reservation request for the next step, i.e. for tiles 4 and 9 in this case, but these tiles 4 and 9 have not yet been occupied by vehicle A. The fact that tiles 4 and 9 are reserved for vehicle A therefore means that the central control server has determined that such a reservation will not lead to a deadlock situation. It can be seen in FIG. 1d that vehicle A has moved further according to the next step mentioned above to tiles 4 and 9 reserved for vehicle A. It can also be seen that the reservation of tiles 3 and 7 by vehicle A has been lifted because vehicle A has completely left these tiles 3 and 7. Tile 8 is still reserved since tile 8 is still occupied in FIG. 1d.

Although in the previous example vehicle A requested reservation of tiles 4 and 9 in FIGS. 1a and 1b, such a request could also be more extensive, e.g. also for tiles 5 and 10 if the next step for vehicle A, in addition to tiles 4 and 9, also involved tiles 5 and 10. Thus, a larger movement could be made by vehicle A in one go. From the point of view of efficient use of the available processing power of the central control server, it may be advantageous for the step sizes to be larger than only those of the next tile (or group of tiles, such as tiles 4 and 9) which at least would be occupied by further movement of the vehicle in question along to its movement path. Said reservations requests could also be generated by the central control server instead of by the vehicles.

FIG. 2a shows a snapshot of a rectangular portion of a floor/movement area which, in this example, comprises only square tiles. The tiles are numbered from 1 to 12. The associated logistics system further comprises six vehicles A to F which, in operation, communicate wirelessly with a central control server of the system. The system also comprises still other vehicles which, while located within the travel area, are not in the portion shown in FIG. 2a, nor in the immediate vicinity thereof, and so, for the sake of clarity, these vehicles will not be considered in the following analysis.

Vehicles A to F are each designed to move according to their respective movement paths to move products within the movement area. Vehicles A to F each have at least one carrying member, such as, for example, a tiltable carrier, for carrying at least one of the products in question per carrying member. By tilting the carrier leaf from a horizontal orientation to a inclined orientation, a product can be made to slide off a carrier leaf and, for example, fall into a chute. The vehicle in question is then available again to transport a next product. Such a vehicle is described in publication EP 3608264 A1. With other suitable vehicles, such as described in publication WO 2019083199 A1 for example, there is a stationary carrier leaf and the products are taken off and placed on the carrier leaf by pick-and-place robots. In another embodiment, such as described in publication WO 2019183220 A1 for example, the vehicles comprise a carrier leaf designed as an endless conveyor belt. All sorts of variants of such vehicles are well known to a person skilled in the art. The present invention is not directed at specific embodiments of such vehicles, for which reason a detailed description may be omitted here and the above reference to vehicles according to the prior art will suffice, inter alia.

The portions of the movements paths already completed by vehicles A to F cannot be deduced from the figure but are irrelevant in any case. Arrows 21A to 21F show how the respective movement paths of vehicles A to F continue from their current positions.

Arrows 21A to 21F are all rectilinear but it is clear that, in practice, movement paths may also be non-rectilinear and may comprise portions which, for example, connect at right angles to one another in a tile. Depending on the embodiment of the vehicle in question, it may be necessary for the vehicle to rotate through 90 degrees in order to carry out such an angular movement such that, if the vehicle fits within the periphery of a tile with limited clearance, for example, the vehicle would also occupy tiles surrounding the tile during such a rotation. The surrounding tiles would then first have to be reserved by the central control system in response to a request for such a reservation by or for the purpose of the vehicle.

At the time of FIG. 2a, vehicles A and C to F are in the middle of tiles 2, 5, 8, 11 and 12, respectively. Vehicle B is moving from tile 4 to tile 3 and thus occupies both tiles 3 and 4. At the same time, vehicle C requests that the central control server reserve tile 6 so as to carry out a next step on its movement path. Thus, in this example, the next step comprises only one tile, but it is also possible for a next step to comprise a number of contiguous tiles. If vehicle C were then to make this reservation and vehicle B were also to continue on its movement path insofar as it has been reserved for vehicle B, the situation would be as shown in FIG. 2b with the observation that vehicle B lies within the periphery of tile 3 only. The reservation of tile 4 for vehicle B is therefore lifted and expires.

In the situation shown in FIG. 2a, tile 6 is in principle available to be reserved for vehicle C as none of the other vehicles has reserved tile 6. However, the central controller will grant such a request for reservation of tile 6 only on condition that the central controller has determined that no deadlock situation would arise, or at least would not necessarily arise, because of such a potential reservation. On the basis of FIGS. 3a to 3g and FIGS. 4a to 4g, a methodology is explained below that is applied in two different ways, by means of which the aforementioned determining operation can be carried out. In both ways, the situation according to FIG. 2b is the starting point, i.e. the situation in which it is hypothetically assumed that tile 6 is reserved for vehicle C and that vehicle C has then also moved according to its next step to the end of its movement path insofar as it has been reserved for vehicle C, i.e. to tile 6. All other vehicles have also moved to the end of their respective movement paths in the situation shown in FIG. 2b, insofar as the corresponding tiles are reserved for the respective vehicles. In FIG. 2b this actually only applies to vehicle B.

From that situation, for each vehicle A to F, the situations that could arise if the vehicles A to F in question were to move further along their respective movement paths by a single tile are considered. In FIG. 3a, these respective movements are represented by arrows 31A to 31F, where the endpoints of these arrows indicates the range of the analysis.

Based on FIG. 3a, only vehicles C and E can make their respective moves, namely by moving to tile 7. FIG. 3b shows the situation in which vehicle C would have thus moved, making tile 6 available for vehicle A. FIG. 3c shows the situation in which vehicle A has then moved to tile 6, making tile 2 available for vehicle B. FIG. 3d shows the situation in which vehicle B has moved to tile 2, making tile 3 available. There is no need for any of the other vehicles to reserve tile 3 within the aforementioned range. The situation thus created is not characterized as a circular wait state. Simply put, this can be deduced from the fact that the arrows do not form a closed circle in FIG. 3d. While vehicles D, E and F are not yet able to move along their movement paths in the situation shown in FIG. 3d, it is not ruled out that vehicle C will be able to do so. For example, vehicle C could move to tile 3 as a continuation of its movement path, after which vehicles E, F and D could continue on their respective movement paths along the arrows in FIG. 3d. It has therefore been established that within the aforementioned range, there is a free-run situation, or at least a potential free-run situation, and it has therefore been determined that a deadlock situation will not occur (at least not with certainty) within the aforementioned range because it has been established that after tile 6 has been reserved for vehicle A, there is a possible sequence of movements of vehicles A to F in which there is no deadlock situation, or at least it has not been established with certainty that a deadlock situation will occur within the range. Therefore, the central control unit will accept the request to reserve tile 6 for vehicle C to carry out the next step on its movement path. Tile 6 is thus reserved for vehicle C.

Starting from FIG. 3a, instead of vehicle C, vehicle E could continue on its movement path by moving to tile 7 as shown in FIG. 3e. Vehicle F could then occupy the vacant tile 11 (FIG. 3f) and vehicle D could then occupy the vacant tile 12 (FIG. 3g). The situation is again not characterized by a circular wait state. Therefore, from this point of view too, it is not determined that a deadlock situation will arise and tile 6 can be reserved by the central control server for vehicle C to carry out the next step.

The reservation of tile 6 for vehicle C by the central control server is communicated to vehicle C, e.g. wirelessly, after which local control of vehicle C will ensure that vehicle C moves to tile 6 according to the next step on its movement path. The occupation by vehicle C of tile 6 will be temporary as a vehicle will obviously not remain on a tile permanently. This is even more evident if a reservation request concerns two or more tiles.

FIGS. 4a to 4g relate to the situation in which the range for determining whether a deadlock situation arises is extended. For vehicles C and E, assuming the hypothetical situation according to FIG. 2 in particular, the range of the analysis is increased from a single tile to two tiles as represented by arrows 41C and 41E. For vehicles A, B, D and F, the size of the respective ranges remains the same, namely a single tile as indicated by arrows 41A, 41B, 41D and 41F.

If vehicle C moved to the first next tile 7 (FIG. 4b), vehicle A could move to tile 6 (FIG. 4c) and vehicle B could move to tile 2 (FIG. 4d). Because of the change in the range, i.e. the increase in the range of the analysis for vehicle C from one tile to two tiles in this example, it now follows from this analysis that a deadlock situation will occur because there is a circular wait state. This is illustrated by the arrows for vehicles C to F forming an endless loop in FIG. 4d. This means that vehicles C to F would be in each other's way if they were to continue on their respective movement paths. This analysis therefore does not allow the central control server room to reserve tile 6 for vehicle C.

Theoretically, the situation in which, based on the situation in FIG. 4a, vehicle E instead of vehicle C moved to tile 7 (FIG. 4e) could lead to a situation in which there is no circular wait state. This is not the case however. In the situation according to FIG. 4g too, there is a circular wait state involving vehicles A, B, C and E. Based on this analysis too, there is no room for the central control server to reserve tile 6 for vehicle C. Since neither analysis establishes that a sequence of movements for vehicles A to F is possible such that there is no deadlock situation, the request by or for the purpose of vehicle C to reserve tile 6 will not be accepted. Therefore tile 6 will actually not be reserved for vehicle C.

Insofar as the tiles used in the preceding analysis are downstream or in front of the respective frontmost reserved tiles for each vehicle, the number of relevant tiles per vehicle to be used in the analysis will preferably correspond to the number of tiles involved in the next one or more steps for each of the vehicles for which step the vehicles A, B, D, E and F in question have not yet made a reservation request or which reservation request has previously been rejected. The size of these steps is determined by the central control server at an earlier stage, preferably when the vehicle in question was still at the starting position on its movement path.

After the request by vehicle C to reserve tile 6 has been processed by the central control server, other vehicles will take their turn to submit a request to the central control server to reserve one or more tiles on their movement paths according to the steps defined by the central control server. Using the methodology as explained above with reference to FIGS. 3a to 4f, it can be determined whether such a request by vehicle A to reserve tile 6 will be accepted or not. There will be no deadlock situation, which is easy to see because once vehicle A has moved to tile 6, vehicle B can move on to tile 2, after which vehicle E can move on to tile 7, and after that vehicle F can move on to tile 11 and vehicle D can move on to tile 12.

As an aside, it should be noted that, for the aforementioned analyses based on FIGS. 3a to 3g and FIGS. 4a to 4g, it does not matter whether vehicles A, B, D, E and F are actually occupying a tile or whether a tile has been reserved for that vehicle but is not yet occupied thereby. Such a situation would arise, for example, if in FIG. 4a vehicle D had not yet reached tile 8 but tile 8 had been reserved for vehicle D. At first glance, the impression might be created that the empty tile 8 still allows room for vehicle C to continue on its movement path from tile 7. However, precisely because of the reservation of tile 8 for vehicle D, this is not possible, despite the fact that tile 8 would not actually be occupied by vehicle D.

1. A method for preventing a deadlock situation in a system for transporting products, the system comprising:
a plurality of vehicles, wherein each vehicle is designed to move over a floor in a movement area and is designed to carry a product to be transported;
a central control server designed to control the vehicles, wherein the central control server comprises a digital representation of the movement area, which representation comprises a plurality of contiguous tiles;
wherein the method comprises:
the central control server receiving an order to move a vehicle in the movement area from a starting position of the vehicle to an end position,
in response to the order, the central control server associating a vehicle with a movement path, which movement path runs from the starting position to the end position and comprises a plurality of contiguous tiles which will be occupied by the associated vehicle as the vehicle moves along the movement path,
the central control server receiving a request from an active vehicle and/or generating for the purpose of an active vehicle a request to carry out a subsequent step of reserving at least one subsequent tile on the latter's movement path;
the central control server determining that no deadlock situation in the system arises as a result of the active vehicle carrying out the subsequent step based on:
the one or more tiles which would be occupied by the active vehicle in carrying out the subsequent step if the active vehicle had reached the frontmost tile of the at least one tile belonging to the subsequent step,
the one or more tiles which have been reserved by the control server when determining, with a view to carrying out, the movement path associated with at least one other vehicle and which are occupied by the at least one other vehicle if the at least one other vehicle has reached the frontmost tile of the tiles reserved for the respective at least one other vehicle,
at least one further tile for the active vehicle which, on the movement path associated with the active vehicle, connects to the frontmost tile to be reserved of the at least one tile belonging to the subsequent step, and
at least one further tile for at least one vehicle of the at least one other vehicle which, on the movement path associated with the at least one vehicle of the at least one other vehicle, connects to the frontmost tile reserved for the at least one vehicle,
at least on condition that the control server has determined that there is no deadlock situation in the system, the control server reserving the at least one subsequent tile for the active vehicle and sending the active vehicle a confirmation that the request has been accepted,
at least on condition that the active vehicle has received the confirmation of acceptance, moving the active vehicle along its movement path so that the at least one subsequent tile is occupied,
the central control server lifting the reservation once a vehicle has completely left a tile reserved for that vehicle.

2. The method according to claim 1, wherein the central control server determining that there is no deadlock situation in the system takes place is based on at least one of the following conditions:
at least two further tiles for the active vehicle of which the rearmost, on the movement path associated with the active vehicle, connects to the frontmost tile of the at least one tile belonging to the subsequent step, or
at least two further tiles for at least one vehicle of the at least one other vehicle of which the rearmost, on the movement path associated with the at least one vehicle of the at least one other vehicle, connects to the frontmost tile reserved for the at least one vehicle.

3. The method according to claim 1, further comprising:
the central control server receiving a request from an active vehicle and/or generating for the purpose of an active vehicle a request to reserve at least two subsequent tiles on the latter's movement path; and
the central control server determining that no deadlock situation in the system arises as a result of the active vehicle occupying the at least two subsequent tiles.

4. The method according to claim 1, wherein respective sizes of the steps for which an active vehicle sequentially requests a reservation from the central control server with a view to moving the active vehicle from the starting position to the end position are determined by the central control server when the vehicle is at the starting position.

5. The method according to claim 1, wherein sizes of steps which together determine a movement path differ from one another.

6. The method according to claim 1, further comprising at least one of the following steps:
loading a vehicle with a product to be transported on its movement path, preferably at its starting position; or
unloading the vehicle on its movement path, preferably at its end position.

7. The method according to claim 1, wherein tiles differ from one another in terms of shape and/or size.

8. The method according to claim 1, wherein shape and dimensions of at least one tile are such that at least one of the vehicles does not fit within a periphery of the at least one tile.

9. The method according to claim 1, wherein the vehicles differ from one another in terms of shape and/or size.

10. A system, comprising:
a plurality of vehicles, wherein each vehicle is designed to move over a floor in a movement area and is designed to carry a product to be transported;
a central control server designed to control the vehicles, wherein the central control server comprises a digital representation of the movement area, which representation comprises a plurality of contiguous tiles;
wherein the central control server and the vehicles are further designed for
the central control server receiving an order to move a vehicle in the movement area from a starting position of the vehicle to an end position,
in response to the order, the central control server associating a vehicle with a movement path, which movement path runs from the starting position to the end position and comprises a plurality of contiguous tiles which will be occupied by the associated vehicle as the vehicle moves along the movement path in question,
the central control server receiving a request from an active vehicle and/or generating for the purpose of an active vehicle a request to carry out a subsequent step of occupying at least one subsequent tile on the active vehicle's movement path;
the central control server determining that no deadlock situation in the system arises as a result of the active vehicle carrying out the subsequent step, wherein a deadlock situation is a situation in which the active vehicle and at least one other vehicle cannot move further along their associated movement paths because the vehicles block each other's movement paths, based on:
the one or more tiles which would be occupied by the active vehicle in carrying out the subsequent step if the active vehicle had reached the frontmost tile of the at least one tile belonging to the next step,
the one or more tiles which have been reserved by the control server when determining, with a view to carrying out, the movement path associated with at least one other vehicle and which are occupied by the at least one other vehicle if the at least one other vehicle has reached the frontmost of the tiles reserved for the respective at least one other vehicle,
at least one further tile for the active vehicle which, on the movement path associated with the active vehicle, connects to the frontmost tile of the at least one tile belonging to the subsequent step, and
at least one further tile for each at least one other vehicle which, on the movement path associated with the at least one vehicle, connects to the frontmost tile reserved for the at least one vehicle,
at least on condition that the control server has determined that there is no deadlock situation in the system, the control server reserving the at least one subsequent tile and sending the active vehicle a confirmation that the request has been accepted,
at least on condition that the active vehicle has received the confirmation of acceptance, moving the active vehicle along its movement path so that the at least one subsequent tile is occupied,
the central control server lifting the reservation once a vehicle has completely left a tile reserved for that vehicle.

11. The method according to claim 6, wherein the method further comprises at least one of the following:
loading a vehicle with a product to be transported on its movement path at its starting position; or
unloading the vehicle on its movement path at its end position.
